(19) United States
(12) Patent Application Publication
(10) Pub. No.: US 2008/0016267 A1
(43) Pub. Date: Jan. 17, 2008

(54) MEMORY CONTROLLER, FLASH MEMORY SYSTEM HAVING MEMORY CONTROLLER, AND METHOD FOR CONTROLLING FLASH MEMORY

(75) Inventor: Tsuyoshi OYAIZU, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 11/766,549

(22) Filed: Jun. 21, 2007

(30) Foreign Application Priority Data
Jun. 30, 2006 (JP) 2006-181732

(51) Int. Cl. G06F 12/00

(52) U.S. Cl. 711/103; 711/E12.008

(57) ABSTRACT

An object of the present invention is to provide a memory controller which can increase a data transfer rate to a flash memory in the case where an access indication whose access area is continuous is continuously given from a host system.

In the case where a sector count written in a sector count register R2 as information which indicates the access operation is m, the memory controller according to the present invention starts a access operation after a physical block address register R11, a sector number register R12, and a counter R13 in the flash memory interface block 8 is set as if the sector count n which is greater than m (n>m) is given. Thereafter, information which indicates the access operation is written a command register R1, a sector count register R2, and a LBA register R3, then if the access area based on this information is continuous, the access operation is maintained.

### PRIORITY CLAIM

This application claims priority from Japanese patent application No. 2006-181732, filed on Jun. 30, 2006, which is incorporated herein by reference.

### BACKGROUND OF THE INVENTION

1. Field of the Invention

The present invention relates to a memory controller, a flash memory system having the memory controller, and a method for controlling a flash memory.

2. Description of the Related Art

Recently, flash memories are widely used as semiconductor memories such as memory cards and silicon disks that are used in a memory system. A flash memory is a kind of nonvolatile memories. It is required that data stored in a flash memory be retained even when electric power is not supplied to the flash memory.

A NAND type flash memory is a kind of flash memories used particularly frequently in the memory system described above. Each of a plurality of memory cells included in a NAND type flash memory can change from an erased state where data representing a logic value “1” is stored to a written state where data representing a logic value “0” is stored, independently from the other memory cells.

Contrary to this, when at least one of the plurality of memory cells has to change from the written state to the erased state, each memory cell cannot change independently from the other memory cells. At this time, a predetermined number of memory cells included in a so-called block have to change to the erased state simultaneously. This simultaneous erasing operation is generally called “block erasing”. The writing operation or the reading operation to a NAND type flash memory is performed at a predetermined number of memory cells included in a so-called page or sector.

A host interface of an external bus of the memory system using a NAND type flash memory is usually adopted ATA (AT Attachment) which is used with a magnetic disk drive. If a page or a sector included in a page of a NAND type flash memory is made equivalent to a sector in the magnetic disk drive, the magnetic disk drive can be transposed to the memory system using a NAND type flash memory comparatively easily. For this reason, the memory system using a NAND type flash memory is more often used for the application which replaces the conventional magnetic disk drive.

For example, when a host computer accesses to a flash memory with the interface based on ATA, a LBA register, a sector count register, a command register, etc. are used.

Here, when executing a reading or a writing to the flash memory from the host computer, a start address of a sector which executes the writing or the reading is set to the LBA register, and a reading sector count (a sector count of data read from the flash memory) or a writing sector count (a sector count of data written to a flash memory) is set to the sector count register. In addition, commands such as the reading and the writing are set to the command register. According to this setting, in case of writing, the data is written to one or more sectors in the flash memory, and in case of reading, the data is read from one or more sectors in the flash memory.

As a flash memory controller equipped the interface base on ATA as mentioned above did not comprise a plurality of LBA registers and a plurality of sector count registers, when accessing the flash memory from a host system, a desirable setting had to be set to the LBA register, the sector count register, and the command register whenever the writing or the reading operation was executed to each data group (the data consisted of a plurality of sectors whose address are continuous). Consequently, when reading a plurality of data groups from a plurality of parts in the flash memory or writing a plurality of data groups to a plurality of parts in the flash memory, the desirable setting had to be set to the LBA register, the sector count register, and the command register whenever the writing or the reading operation was executed to each data group.

So, Japanese Patent Publication No. 2006-99517A discloses a suitable memory controller, a flash memory system having the memory controller, and a method for controlling the flash memory, when continuously executing the reading operation or the writing operation for a plurality of data groups.

FIG. 5 is an explanatory view showing a host interface block 7 of said application. The host interface block 7 comprises a plurality of LBA registers R3 in which an address provided from a host system 4 is written and a plurality of sector count registers R2 in which a sector count provided from the host system 4 is written. For example, as shown in FIG. 5, the LBA registers A, B, C, . . . , J and the sector count registers A, B, C, . . . , J corresponding to these is provided in the host interface block 7. Further, the host interface block 7 comprises the command register R1 in which the command provided from the host system 4 is written.

In a flash memory system 1 of said application, according to the addresses and the sector counts written in the LBA registers R3 and the sector count registers R2, in case of writing, the data which saves in a buffer 9 is written to the flash memory 2, in case of reading, the data is read from the flash memory 2.

As a plurality of the addresses and a plurality of the sector counts can be written in the LBA registers R3 and the sector count registers R2 in the operation of this flash memory system, the operation of a plurality of data groups can be continuously executed by setting a plurality of addresses and a plurality of sector counts with the an external command at first.

### BRIEF SUMMARY OF THE INVENTION

According to the prior art, with comprising a plurality of the LBA registers and a plurality of the sector count registers in the host interface block, the host system could specify a plurality of access areas. Therefore, the flash memory controller could prepare information about a second access area while accessing a first access area, and could prepare information about a third access area while accessing the second access area. Although each access area did not need to be a successive area, the flash memory controller gave an access indication to the flash memory interface in every access area.

When executing reading or writing to the flash memory, the host system might continuously give an indication information which indicates the reading or the writing to successive access area. In this case the flash memory controller in prior art had to give the access indication to the flash memory interface block in every access operation corresponding to each indication information. Therefore, there is a problem that a data transfer rate decreases between the host system and the flash memory, even though the access area is continuous, as the reading or the writing is not continuously executed at single sequence operation.

Therefore, it is an object of the present invention to provide a memory controller, a flash memory system having the memory controller, and a method for controlling the flash memory that can increase a data transfer rate between the host system and the flash memory in the case where the indication information which indicates the reading or the writing to successive access area is continuously given by the host system.

According to the present invention, a memory controller for controlling an access to a flash memory that saved data is erased in a block unit, according to an indication information given by a host system is provided, which comprising:

reading and writing means for starting a operation reading data saved in said flash memory or a operation writing data to said flash memory for an area which is more than a writing area or a reading area specified based on said indication information; and indication information retaining means for retaining said indication information; and judging means for judging whether a writing area or a reading area specified based on a new indication information given by said host system is continuous with the writing area or the reading area specified based on information retained by said indication information retaining means; and controlling means for maintaining the reading operation or the writing operation which said reading and writing means is executing when said judging means judges that these areas are continuous, and halting the reading operation or the writing operation which said reading and writing means is executing when said judging means judges that these areas are not continuous.

According to the present invention, the flash memory system is provided, which comprises: a flash memory; and a memory controller comprising: reading and writing means for starting a operation reading data saved in said flash memory or a operation writing data to said flash memory for an area which is more than a writing area or a reading area specified based on said indication information; and indication information retaining means for retaining said indication information; and judging means for judging whether a writing area or a reading area specified based on a new indication information given by said host system is continuous with the writing area or the reading area specified based on information retained by said indication information retaining means; and controlling means for maintaining the reading operation or the writing operation which said reading and writing means is executing when said judging means judges that these areas are continuous, and halting the reading operation or the writing operation which said reading and writing means is executing when said judging means judges that these areas are not continuous.

Further, it is preferable that said reading and writing means is starting a operation reading data saved in said flash memory or a operation writing data to said flash memory for an area up to a last page in a block specified based on said indication information.

Further, it is preferable that said reading and writing means is starting a operation reading data saved in said flash memory or a operation writing data to said flash memory for data of a sector count which is more than data of a sector count specified based on said indication information.

Further, it is preferable that said judging means is judging whether said writing area or said reading area is continuous or not by a logical block address (LBA) and a sector count in said indication information given by said host system.

Further, it is preferable that said judging means is further judging that said writing area or said reading area is not continuous when a external command included in a new indication information and a external command retained by said indication information retaining means are not same.

Further, it is preferable that said controlling means is halting the reading operation or the writing operation after finishing reading or writing for the reading area or the writing area specified based on information retained by said indication information retaining means.

According to the present invention, a method for controlling an access to a flash memory that saved data is erased in a block unit, according to an indication information given by a host system is provided, which comprises: reading and writing step of starting a operation reading data saved in said flash memory or a operation writing data to said flash memory for an area which is more than a writing area or a reading area specified based on said indication information; and indication information retaining step of retaining said indication information; and judging step of judging whether a writing area or a reading area specified based on a new indication information given by said host system is continuous with the writing area or the reading area specified based on information retained by said indication information retaining step; and controlling step of maintaining the reading operation or the writing operation which said reading and writing step is executing when said judging step judges that these areas are continuous, and halting the reading operation or the writing operation which said reading and writing step is executing when said judging step judges that these areas are not continuous.

Further, it is preferable that said reading and writing step is starting a operation reading data saved in said flash memory or a operation writing data to said flash memory for an area up to a last page in a block specified based on said indication information.

Further, it is preferable that said reading and writing step is starting a operation reading data saved in said flash memory or a operation writing data to said flash memory for data of a sector count which is more than data of a sector count specified based on said indication information.

Further, it is preferable that said judging step is judging whether said writing area or said reading area is continuous or not by a logical block address (LBA) and a sector count in said indication information given by said host system.

Further, it is preferable that said judging step is further judging that said writing area or said reading area is not continuous when a external command included in a new indication information and a external command retained by said indication information retaining step are not same.

Further, it is preferable that said controlling step is halting the reading operation or the writing operation after finishing reading or writing for the reading area or the writing area specified based on information retained by said indication information retaining step.

According to the present invention, in the case where the access area (the reading area or the writing area) based on the indication information given by the host system is continuous, the access operation (the reading operation or the writing operation) based on a different indication information is continuously executed. Therefore, an interval between each operation, which is a period that the access operation is not executed, can shorten more than the case where an access operation based on a plurality of indication information whose access area is continuous intermittently is executed.

For this reason, the data transfer rate between the host system and the flash memory can be increased when the indication information whose access area is continuous is given by the host system.

Further objects and advantages of the present invention will be apparent from the following description of the preferred embodiments of the invention as illustrated in the accompanying drawings.

### BRIEF DESCRIPTION OF THE SEVERAL VIEWS OF THE DRAWINGS

FIG. 1 is a block diagram schematically showing a flash memory system according to the present invention.

FIGS. 2a and 2b are a schematic diagram of an address space in a flash memory.

FIGS. 3a to 3c are a schematic diagram showing an address translation in a flash memory system.

FIG. 4 is a block diagram schematically showing a host interface block and a flash memory interface block in a flash memory controller according to the present invention.

FIG. 5 is an explanatory view showing a host interface block of a prior art.

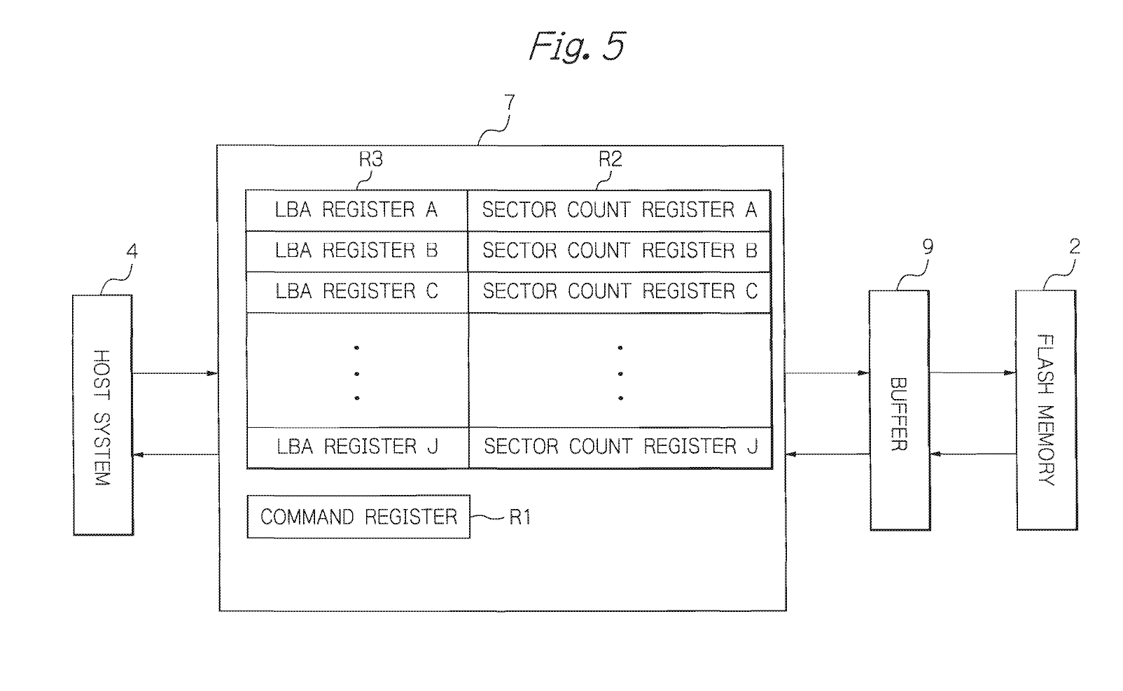

FIG. 6 is a block diagram schematically showing a host interface block and a flash memory interface block in a flash memory system according to the present invention.

FIG. 7 is an example of an address translation table.

FIG. 8 is a schematic diagram showing the continuous execution of the reading or the writing according to the present invention.

### DETAILED DESCRIPTION OF THE INVENTION

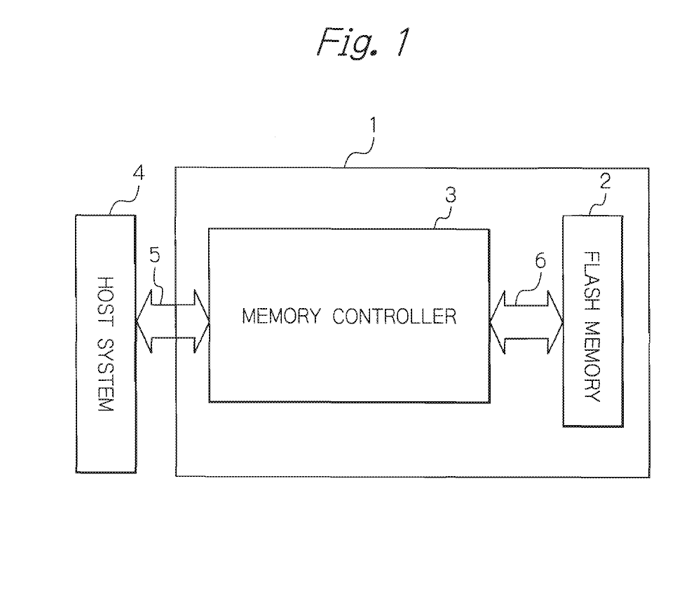

FIG. 1 is a block diagram schematically showing a flash memory system 1 according to the present invention. As shown in FIG. 1, the flash memory system 1 comprises a flash memory 2 and a controller 3 which controls it. These are connected to each other via an internal bus 6. Also, the flash memory system 1 is usually connected to a host system 4 via an external bus 5, and is used as a kind of external storage device to the host system 4.

The host system 4 may be an information processing apparatus of various types such as a personal computer, a digital still camera, etc. for processing text, audio, image information, and other kinds of information.

The host system 4 supplies an indication information which indicates an execution of the operation to the memory controller 3. Replying the indication information, the memory controller 3 supplies an indication information which indicates the execution of the operation to the flash memory 2. In this case the indication information comprises a command which indicates the reading or the writing and an address which indicates an access area. Also a command supplied from the host system 4 to the memory controller 3 is called an external command. A command supplied from the memory controller 3 to the flash memory 2 is called an internal command.

Below, the detail of the flash memory 2, an address space of the flash memory 2, and the memory controller 3 will be explained.

In the flash memory 2, a block, which is an erasing operation unit and which is constituted of predetermined number of memory cells, is comprised of a plurality of pages. Although the constitution of blocks and pages is different by specifications of the flash memory, in standard flash memory one block consists of 32 pages at small block, or one block consists of 64 pages at large block.

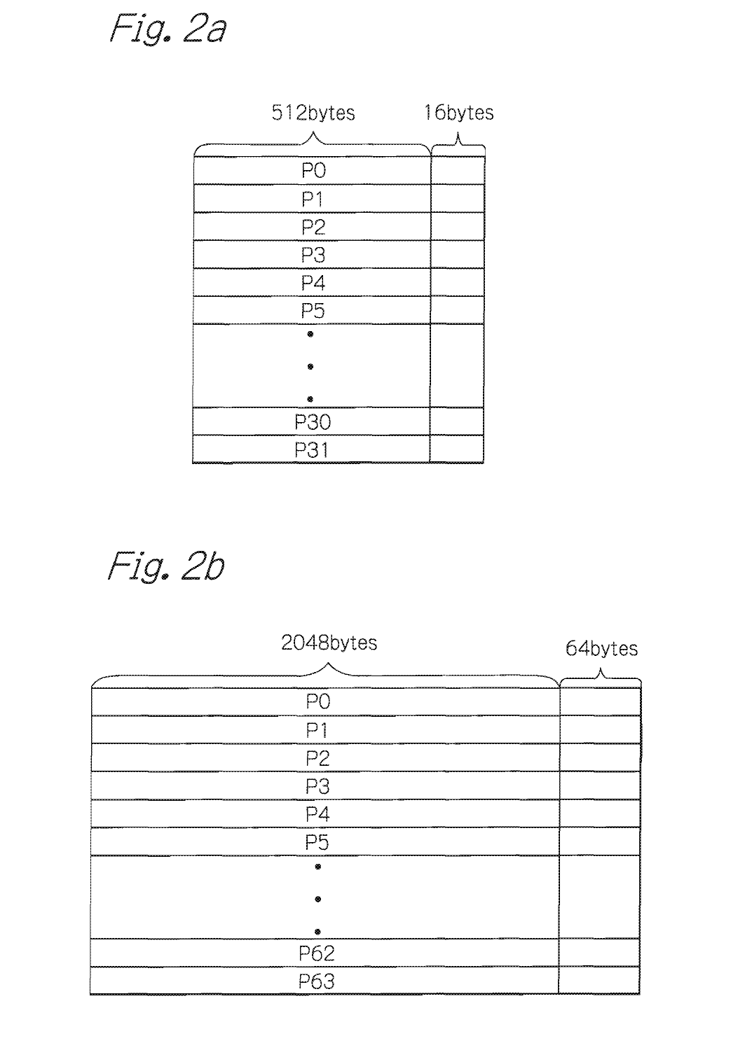

The constitution of the page will be described below. At small block, as shown in FIG. 2a, one page consists of user area of one sector (a 512-byte) and a 16-byte redundant area. At large block, as shown in FIG. 2b, one page consists of user area (below, the user area divided in four is called a sector area.) of four sectors (a 2048-byte) and a 64-byte redundant area, and each of the user area and the redundant area are used with dividing in four. Thus at small block one page corresponds to one sector area, and at large block one page corresponds to four sector areas.

The user area mainly stores data supplied from the host system. The redundant area stores additional information representing an error correction code (ECC), information indicating a logical block, etc. The information indicating a logical block is information which indicates a logical block determined based on address information supplied from the host system. The error correction code is information used for detecting and correcting an error included in the data stored in the user area.

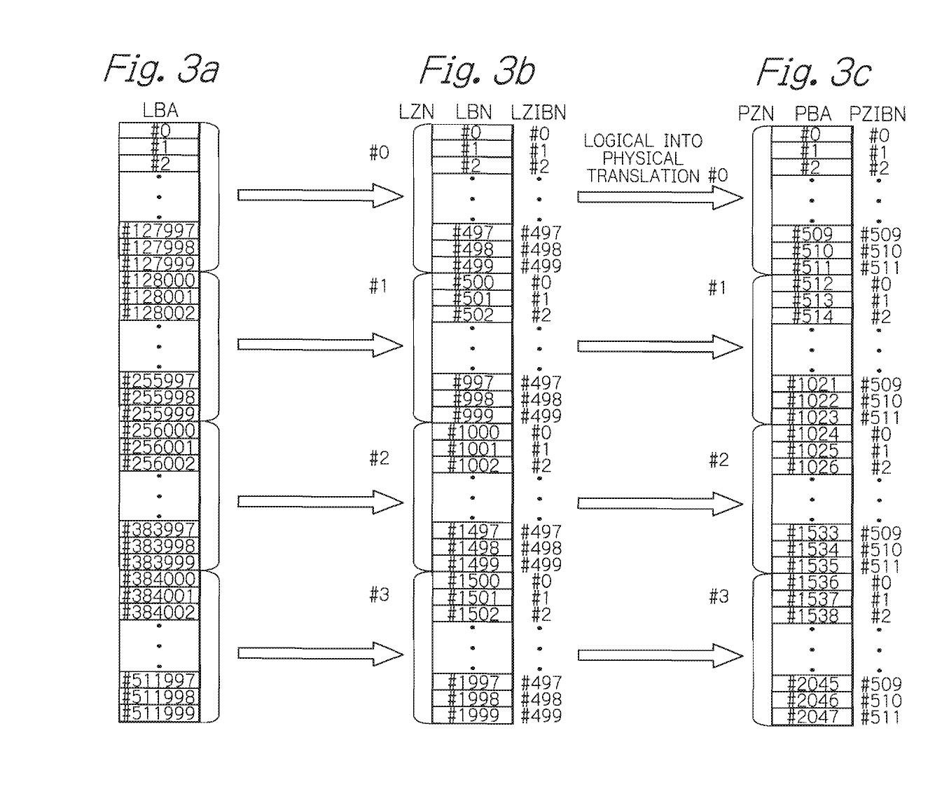

As shown in FIG. 3a, the address space of host system 4 is managed by a LBA (Logical Block Address) which is a serial number assigned the area divided by the sector (512-bytes). A block collected a plurality of sectors is called a logical block, and a zone collected a plurality of logical blocks is called a logical zone. As shown in FIG. 3b, a serial number assigned the logical block is called logical block number (LBN), and a serial number of the logical block in the logical zone is called a block number in logical zone (LZIBN). Besides, the LBA of a sector which the reading or the writing is started from is set in the LBA register.

Contrary, as shown in FIG. 3c, a physical block address (PBA) is fixedly assigned to each physical block. Further, in case of managing a storage area by divided in a plurality of zones, a physical zone consists of a plurality of physical blocks, and a physical zone number (PZN) is assigned to each physical zone. A serial number of the physical block in each physical zone is called a block number in physical zone (PZIBN).

Also, one physical zone is assigned to each logical zone, and the data corresponding to each logical block included in the logical zone is written in the physical block included in the physical zone corresponding to its logical zone. Thus, the sector count included in one logical block is set depending on the sector count included in one physical block. However, in the case of assigning one logical block to a plurality of physical blocks, considering these physical blocks as one physical block, the sector count included in one logical zone is set.

In a case shown in FIG. 3, as the flash memory that one physical block has 256 sector areas is supposed, 256 sectors correspond to one logical block. Thus, the logical zone of LZN #0 which is comprised of 500 logical blocks of from LBN #0 to LBN #499 corresponds to 128,000 sectors area of LBA #0 to #127,999.

Similarly, the logical zone of LZN #1 corresponds to 128,000 sectors area of from LBA #128,000 to LEA #255,999, and the logical zone of LZN #2 corresponds to 128,000 sectors area of from LBA #256,000 to LBA #383,999, and the logical zone of LZN #3 corresponds to 128,000 sectors area of from LBA #384,000 to LBA #511,999.

Also, the logical zone of LZN #0 which is comprised of 500 logical blocks of from LBN #0 to LBN #499 is assigned to the physical block of PZN #0 which is comprised of 512 physical blocks of from PEA #0 to PEA #511. Similarly, the logical zone of LZN #1 is assigned to the physical block of PZN #1, and the logical zone of LZN #2 is assigned to the physical block of PZN #2, and the logical zone of LZN #3 is assigned to the physical block of PZN #3. A reason why the number of physical blocks included in the physical zone are greater than the number of logical blocks included in the logical zone is because it is considered that old data and new data corresponding to a same logical block exist simultaneously in different physical blocks or that a bad block which cannot write data normally has occurred or etc.

Also, in each physical block, as data of the logical block assigned its physical block is written in the order of a LBA, a relationship between a LBA given by the host system 4 and an access area in flash memory 2 can be managed by managing a relationship between the physical block and the logical block.

The relationship between the physical block and the logical block changes every writing of data or erasing. Thus an address translation table is generated in order to manage the relationship between both in every time. The address translation table is updated in every time when the relationship changes.

The address translation table is generated based on information indicating a logical block (below, it is called a logical address information) written in the redundant area of a first page of the physical block. As the logical address information written in the redundant area, information which can specify the logical block such as the LBN is used. But, in case of having set the relationship between the physical zone and the logical zone previously, as the logical block is specified based on the LZIBN, it prefer to use the LZIBN which is less data than the LBN.

Also, in case of not having stored the logical address information in said the physical block, as the logical block corresponding to the physical block does not exist, the physical block can be judged as a free block. In short, in case of not having stored the logical address information, the physical block can be judged as the free block.

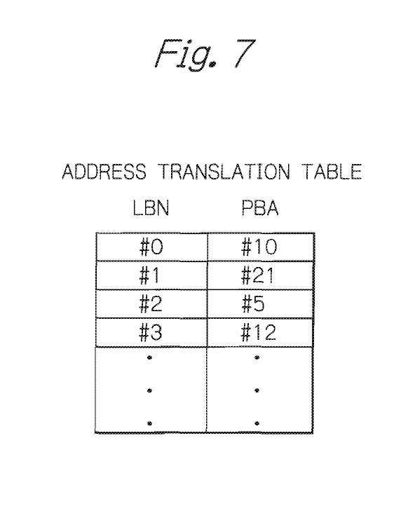

FIG. 7 is an example of the address translation table. In this figure, a left shows the LBN of the logical block, and a right shows the PBA of the physical block. In this example, the logical block of LBN #0 corresponds the physical block of PBA #10, and the logical block of LBN #1 corresponds the physical block of PBA #21, and the logical block of LBN #2 corresponds the physical block of PBA #5. But, in case of having set the relationship between the physical zone and the logical zone previously, the relationship between the logical block and the physical block may be shown by the relationship between the LZIBN and the PZIBN.

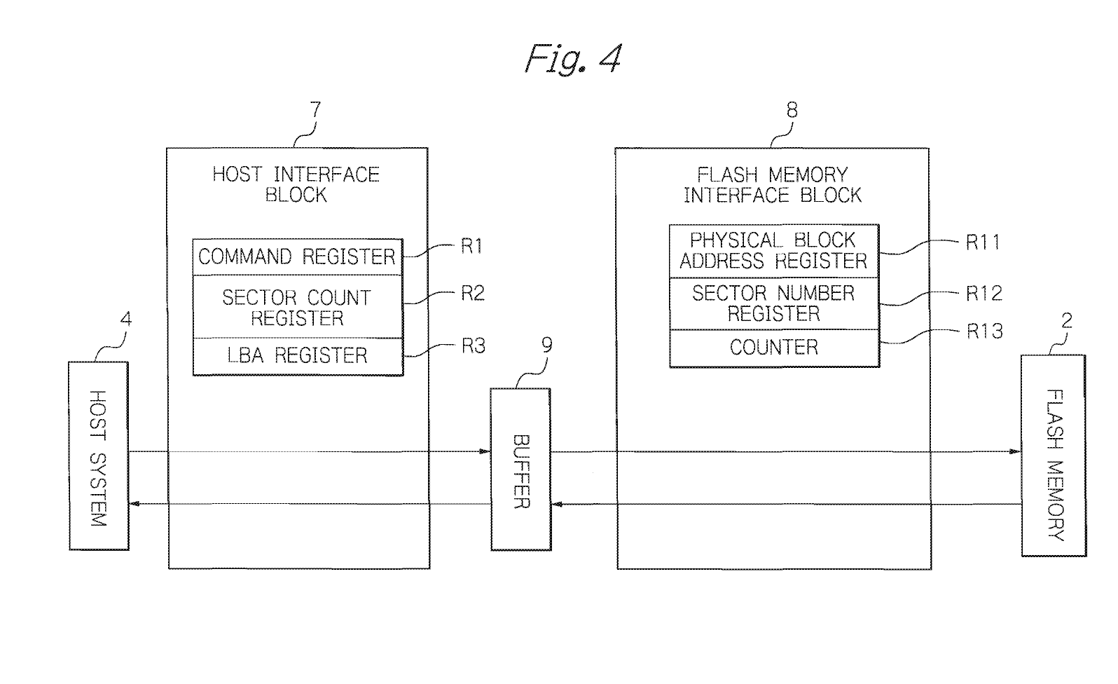

As shown in FIG. 4, the memory controller 3 comprises various registers, a buffer 9 and a work area (not shown). That is, the host interface block 7 comprises a command register R1, a sector count register R2, and a LBA register R3. Also, the flash memory interface block 8 comprises a physical block address register R11, a sector number register R12, a counter R13, and etc.

The buffer 9 is a functional block for retaining data read from the flash memory 2 and data to be written on the flash memory 2. Data read from the flash memory 2 is retained in the buffer 9 until output to the host system 4. Data to be written on the flash memory 2 is retained in the buffer 9 until the flash memory 2 is ready for writing operation. The work area is a memory module for temporarily storing data used for controlling the flash memory 2. The work area is formed of a plurality of SRAM (Static Random Access Memory) cells.

Information given by the host system 4 is written in the command register R1, the sector count register R2, and the LBA register R3. A command (an external command which indicates the writing or the reading), for example a write command, a read command, etc., is written in the command register R1. A sector count of an access area is written in the sector count register R2. A top LBA in the access area is written in the LBA register R3.

Information based on the information written in the sector count register R2 and the LBA register R3, which indicates an access area in the flash memory 2, is written in the physical block address register R1, the sector number register R12, and the counter R13.

For example in case of assigning the 256 sector areas which the LBA is continuous to one physical block of flash memory 2 (in this case, one block consists of 64 pages and one page consists of 4 sectors), lower 8 bits of the LBA explained in FIG. 3 correspond to a sector number SN, the other upper bits except the lower 8 bits correspond to a logical block number (LBN).

In other words, in the case where the 256 sector areas which the LBA is continuous is one logical block, lower 8 bits of the LBA indicate the sector number SN (0 to 255) which is a serial number assigned each sector in the logical block, and the other upper bits except the lower 8 bits of the LBA indicate the logical block number (LBN). Besides, a bit count of the LBA, the logical block number (LBN), and the sector number SN is determined by a capacity or a specification of the flash memory 2.

Next, information set in the physical block address register R11, the sector number register R12, and the counter R13 will be explained. A value of part corresponding to the sector number SN of the LBA written in the LBA register R3 is written in the sector number register R12.

As a user data is written in each physical block in the order of the LBA, said sector number SN corresponds the serial number assigned the sector area contained each physical block. On the other hand, the physical block address (PBA) of the physical block corresponding to the logical block specified based on the part which indicates the logical block number (LBN) of the LBA written in the LBA register R3 or the physical block address (PEA) of the free block is written in the physical block address register R11.

In other words, in the case of reading the user data from the physical block corresponding to specified logical block, or in the case of additional writing to the physical block, the physical block address (PBA) of the physical block corresponding to specified logical block is written in the physical block address register R11. Also, in the case of writing the user data corresponding to specified logical block to a free block, the physical block address (PBA) of the free block is written in the physical block address register R11. The sector count set in the sector count register R2 is written in the counter R13.

When the access area specified based on information set in the LBA register R3 and the sector count register R2 overlaps with a plurality of the logical blocks, as the physical block of the access area also overlaps with a plurality of the logical blocks, the setting of information to the physical block address register R11, the sector number register R12, and the counter R13 is performed each logical block, and the sector count of the user data which is written in each logical block is set in the counter R13.

Therefore, when the access area specified based on information set in the LBA register R3 and the sector count register R2 overlaps with a plurality of the logical blocks, a plurality of sequence operations is executed based on one indication information given by the host system 4, for example, if the access area overlaps with two logical blocks, two sequence operations are executed. The sequence operation is an access operation continuously executed based on information set in the physical block address register R11, the sector number register R12, and the counter R13. The sequence operation is executed according to a sequence command (a command set in every operation of the writing, the reading, etc.) which is stored in the ROM of memory controller 3.

In sequence operation of the writing, the value set in the sector number register R12 is incremented by one and the value set in the counter R13 is decremented by one in every time when the user data of one sector is provided to the flash memory 2 from the buffer 9. The sequence operation of the writing finishes when the value set in the counter R13 becomes 0. In sequence operation of the reading, the value set in the sector number register R12 is incremented by one and the value set in the counter R13 is decremented by one in every time when the user data of one sector is read to the buffer 9 from the flash memory 2. The sequence operation of the reading finishes when the value set in the counter R13 becomes 0.

For example, in case of setting “10” in the sector number register R12 and setting “8” in the counter R13, the user data is written in the sectors area of from SN #10 to SN #17 in sequence operation of the writing. Also, in case of setting “10” in the sector number register R12 and setting “8” in the counter R13, the user data is read in the sectors area of from SN #10 to SN #17 in sequence operation of the reading.

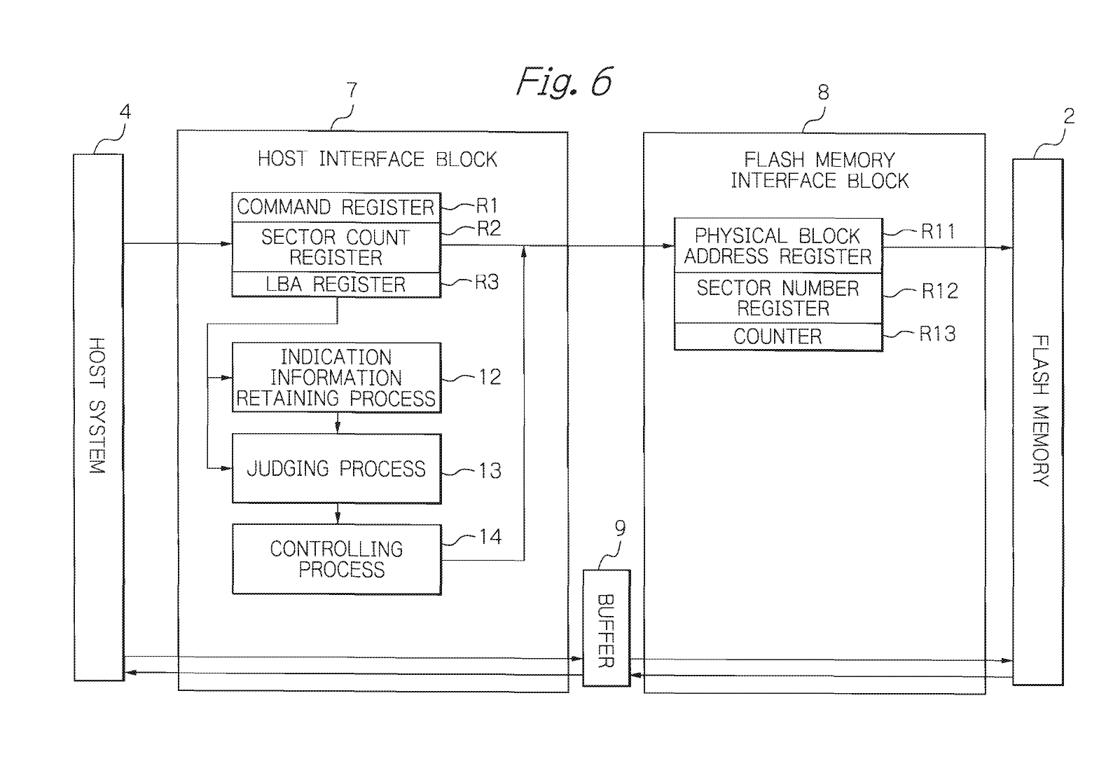

FIG. 6 is a block diagram schematically showing a flash memory system according to the present invention. The embodiment of the present invention will be explained by this figure.

First, the first indication information is given by the host system 4 to the host interface block 7. The indication information consists of information about the external command which indicates the reading, the writing, etc., the sector count which specifies the access area, and the LBA. These information are written in the command register R1, the sector count register R2, and the LBA register R3 in the host interface block 7, respectively. An indication information retaining process 12 is a process retaining information about the external command, the sector counts, and the LBA which are included in the previous indication information, but when the first indication information is given, these information is not retained. A judging process 13 judges whether an access area (the reading area or the writing area) specified with the indication information given by the host system is continuous with an access area specified with information retained by the indication information retaining process. In other words, the judging process 13 judges whether the access area specified with information written in the command register R1, the sector number register R2, and the LBA register R3 is continuous with the access area specified with the external command, the sector count, and the LBA retained by indication information retaining process. Therefore, when the first indication information is given by the host system 4, the judging process 13 judges that the access area is not continuous. When the judging process 13 judges that the access area is continuous, a controlling process 14 maintains the access operation (the reading or the writing) which the flash memory interface block 8 is executing, but when the judging process 13 judges that the access area is not continuous, the controlling process 14 halts the access operation (the reading or the writing) which the flash memory interface block 8 is executing, and performs a setting for executing a new access operation. However the controlling process 14 does not halt the access operation and starts a setting for executing an access operation as the flash memory interface block 8 does not execute the access operation when the first indication information is given. Also, the indication information retaining process 12 retains information written in the command register R1, the sector count register R2, and the LBA register R3 in a work area (not shown) after the judging process 13 judges whether the access area is continuous or not.

In setting for executing an access operation, information which specifies the access area in the flash memory 2 is set in the physical block address register R11, the sector number register R12, and the counter R13 in the flash memory interface block 8. The physical block address (PBA) of the physical block corresponding to the logical block specified based on the part which indicates the logical block number (LBN) of the LBA written in the LBA register R3 or the physical block address (PBA) of the free block is written in the physical block address register R11. Besides, the physical block address (PBA) of the physical block corresponding to the logical block is obtained by the address translation table. A value of the part corresponding to the sector number SN of the LBA written in the LBA register R3 is written in the sector number register R12. The value which is greater than the sector count written in the sector count register R2 is written in the counter R13. After information which specifies the access area in the flash memory 2 is set in the physical block address register R11, the sector number register R12, and the counter R13, the sequence command corresponding to the external command set in the command register R1 is read from the ROM, then the access operation is started according to the read sequence commands.

Next, the value set in the counter R13 will be explained. In this embodiment, the value which can access up to a last page (a sector area) of the physical block is set in the counter R13. For example, when one physical block is comprises of 256 sector areas (256 sector areas corresponding to the sector number SN of from #0 to #255), the value which can access up to the sector area corresponding to the sector number SN #255 is written in the counter R13.

In the case where the value of the part which indicates the logical block number (LBN) of the LBA written in the LBA register R3 is i, the value of the part corresponding to the sector number SN is j, and the value written in the sector count register R2 is k, not k but 256−j is written in the counter R13. Besides, the physical block address (PBA) corresponding to the logical block number (LBN) #i is written in the physical block address register R11, and j is written in the sector number register R12. Also, in this setting, the sector area corresponding to the sector number of from SN #j to SN #255 can be accessed.

When the access area is overlapped in two physical blocks (in the case where k is greater than 256−j), information which specifies the access area is set in addition in the physical block address register R11, the sector number register R12, and the counter R13 after the access operation has finished in this setting. In this additional setting, the physical block address (PBA) corresponding to the logical block number (LBN) #i+1 is written in the physical block address register R11, 0 is written in the sector number register R12, and 256 is written in counter R13. In this setting, the sector area corresponding to the sector number of from SN #0 to SN #255 can be accessed.

Next, the case that the second indication information is given by the host system 4 to the host interface block 7 will be explained. Information about the external command, the sector count which specifies the access area, and the LBA, which are included in the second indication information, is written in the command register R1, the sector count register R2, and the LBA register R3, respectively. Also, the indication information retaining process 12 retains information about the external command, the sector count which specifies the access area, and the LBA which are included in the previous indication information, that is, the first indication information. The judging process 13 judges whether the LBA (this LBA is included in the second indication information) written in the LBA register R3 is the next of a last LBA of the access area specified with the sector count and the LBA (this sector count and this LBA are included in the first indication information) which retains in the indication information retaining process 12. Besides, the judging process 13 judges that the access area is not continuous when the external command written in the command register R1 (the external command which is include in the second indication information) and the external command retained by the indication information retaining process 12 (the external command which is include in the first indication information) are not same, for example, one is the external command which indicates the reading, the other is the external command which indicates the writing.

When the access area is continuous, the LBA written in the LBA register R3 equals to the next of a last LBA of the access area specified with the sector count and the LBA retained by the indication information retaining process 12, and when the access area is not continuous, the LBA written in the LBA register R3 does not equal to the next of a last LBA of the access area specified with the sector count and the LBA retained by the indication information retaining process 12. In other words, in the case where the LBA written in the LBA register R3 is a, the sector count and the LBA retained by the indication information retaining process 12 are b and c, respectively, the judging process 13 judges that the access area is continuous if a equals to b+c, and that the access area is not continuous if a does not equal to b+c.

According to the judgment of the judging process 13, the controlling process 14 maintains or halts the access operation which the flash memory interface block 8, which is read/write process, is executing. In other words, in case of judging that the access area is continuous, the access operation which the flash memory interface block 8 is executing is maintained. On the other hand, in case of judging that the access area is not continuous, the sequence operation stops, and the access operation to the flash memory 2 is halted. If the access operation is the data reading operation from the flash memory 2, the sequence operation stops after transporting the all data corresponding to the first indication information to the host system 4. If the access operation is the data writing operation to the flash memory 2, the sequence operation stops after writing the all data corresponding to the first indication information to the flash memory 2.

In the case where the access area is not continuous, information for executing the access operation is set in the physical block address register R11, the sector number register R12, and the counter R13 of the flash memory interface block 8 after halting the sequence operation which the flash memory interface block 8 is executing, and then the new access operation starts. Also, the indication information retaining process 12 retains the information written in the command register R1, the sector count register R2, and the LBA register R3 in the work area (not shown) after the judging process 13 judges whether the access area is continuous or not. In short, the information about the external command, the sector count, and the LBA which include in the second indication information is retained in the indication information retaining process 12.

The action among the flash memory 2, the flash memory interface block 8, the buffer 9, the host interface block 7, and the host system 4 in the embodiment of the present invention will be explained as follows.

In the case of reading, first, the flash memory interface block 8 reads data from the flash memory 2, and retains the data in the buffer 9. Next, the host interface block 7 transports the data to the host system 4 from the buffer 9.

When the buffer 9 has a free area, the flash memory interface block 8 reads data from the flash memory 2, and retains the read data in the buffer 9. When the buffer 9 does not have the free area, the flash memory interface block 8 waits until the free area is generated in the buffer 9, and reads next data after the free area is generated in the buffer 9 with the host interface block 7 transporting the data retained in the buffer 9 to the host system 4. Besides, when the free area is generated with transporting the data retained in the buffer 9 to the host system 4, a flag which indicates the free area is set, and when the data read from the flash memory 2 retains in the buffer 9, the flag which indicates the free area is reset.

According to a request of the host system 4, the host interface block 7 transports the data retained in the buffer 9 to the host system 4. After transporting data of the sector count which the indication information retaining process 12 retains to the host system 4, the host interface block 7 becomes a state waiting the request from the host system 4. The flash memory interface block 8 reads the data from the flash memory until the free area of the buffer 9 becomes empty, and becomes a state waiting to be generated the free area when the free area becomes empty.

Hereafter, giving the indication information from the host system 4, if the access area based on the indication information is continuous, the operation which transports the data retained in the buffer 9 to the host system 4 is re-started by the request of the host system 4.

In the case of writing, first, the host interface block 7 transports the data, which is given by the host system 4 and is written in the flash memory 2, to the buffer 9. Next, the flash memory interface block 8 transports the data in the buffer 9 to the flash memory 2. The flash memory interface block 8 becomes the state waiting for data given by the host system 4 to be retained in the buffer 9 when the buffer 9 does not have the data. Therefore, the flash memory interface block 8 becomes the state waiting for the data given by the host system 4 to be retained in the buffer 9 after transporting the data of sector count which the indication information retaining process 12 retains to the flash memory 2.

Hereafter, giving the indication information from the host system 4, if the access area based on the indication information is continuous, the operation which transports the data retained in the buffer 9 to the host system 4 is re-started when the data given by the host system 4 is retained in the buffer 9.

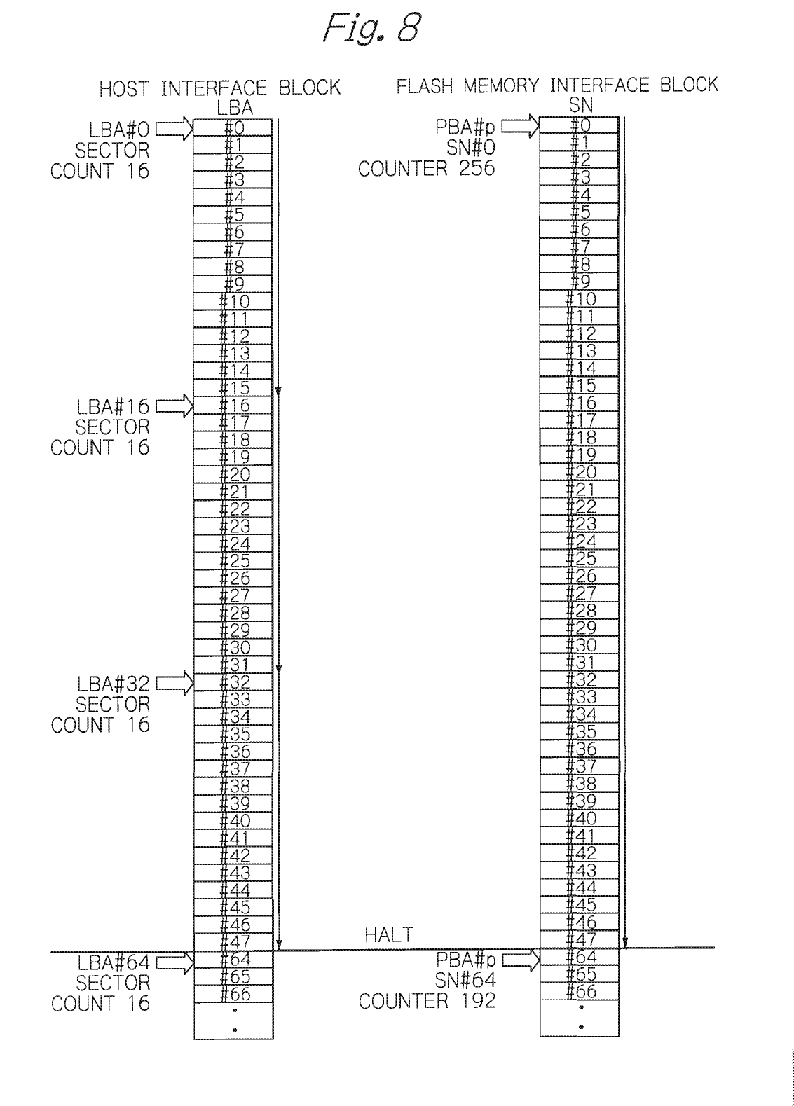

Next, the access operation according to the present invention will be concretely explained with reference to FIG. 8. Hereinafter, the host system 4 gives the external command which indicates the reading, and the logical block number (LBN) #0 corresponds to the physical block address (PBA) #p. First, in the case where the LBA and the sector count given to the host interface block 7 are the LBA=0 and the sector count=16, the physical block address register R11, the sector number register R12, and the counter R13 in the flash memory interface block 8 are set p, 0, 256, respectively, then the reading operation starts. Next, in the case where the LBA and the sector count are the LBA=16 and the sector counts=16, as the access area is continuous, the reading operation is maintained. Next, in the case where the LBA and the sector counts are the LBA=32 and the sector counts=16, as the access area is continuous, the reading operation is maintained. Next, in the case where the LBA and the sector counts are the LBA=64 and the sector counts=16, as the access area is not continuous, the reading operation is halted. Thereafter, the physical block address register R11, the sector number register R12, and the counter R13 in the flash memory interface block 8 are set p, 64, 192, respectively, then the reading operation starts.

Above mentioned, in the access operation according to the present invention, in case of accessing continuous access area, a frequency to indicate the access operation to the flash memory interface block 8 can be vastly decreased.

In this access operation, in the case where the sector count which includes in the indication information given by the host system 4 is m, the access operation starts after the physical block address register R11, the sector number register R12, and the counter R13 in the flash memory interface block 3 is set as if the sector count n which is greater than m (n>m) is given. Thereafter, the host system 4 gives the next indication information, and then if the access area based on this indication information is continuous, the access operation is maintained. Whether the access area is continuous or not can be judged by information including in the indication information.

Many widely different embodiments of the present invention may be constructed without departing from the spirit and scope of the present invention. It should be understood that the present invention is not limited to the specific embodiments described in the specification, except as defined in the appended claims.

1. A memory controller for controlling an access to a flash memory that saved data is erased in a block unit, according to an indication information given by a host system, comprising:
reading and writing means for starting a operation reading data saved in said flash memory or a operation writing data to said flash memory for an area which is more than a writing area or a reading area specified based on said indication information;
indication information retaining means for retaining said indication information;
judging means for judging whether a writing area or a reading area specified based on a new indication information given by said host system is continuous with the writing area or the reading area specified based on information retained by said indication information retaining means; and
controlling means for maintaining the reading operation or the writing operation which said reading and writing means is executing when said judging means judges that these areas are continuous, and halting the reading operation or the writing operation which said reading and writing means is executing when said judging means judges that these areas are not continuous.

2. The memory controller according to claim 1,
wherein said reading and writing means is starting a operation reading data saved in said flash memory or a operation writing data to said flash memory for an area up to a last page in a block specified based on said indication information.

3. The memory controller according to claim 1,
wherein said reading and writing means is starting a operation reading data saved in said flash memory or a operation writing data to said flash memory for data of a sector count which is more than data of a sector count specified based on said indication information.

4. The memory controller according to claim 1,
wherein said judging means is judging whether said writing area or said reading area is continuous or not by a logical block address (LBA) and a sector count in said indication information given by said host system.

5. The memory controller according to claim 1,
wherein said judging means is further judging that said writing area or said reading area is not continuous when a external command included in a new indication information and a external command retained by said indication information retaining means are not same.

6. The memory controller according to claim 1,
wherein said controlling means is halting the reading operation or the writing operation after finishing reading or writing for the reading area or the writing area specified based on information retained by said indication information retaining means.

7. The flash memory system comprising:
a flash memory; and
a memory controller comprising:
reading and writing means for starting a operation reading data saved in said flash memory or a operation writing data to said flash memory for an area which is more than a writing area or a reading area specified based on said indication information;
indication information retaining means for retaining said indication information;
judging means for judging whether a writing area or a reading area specified based on a new indication information given by said host system is continuous with the writing area or the reading area specified based on information retained by said indication information retaining means; and
controlling means for maintaining the reading operation or the writing operation which said reading and writing means is executing when said judging means judges that these areas are continuous, and halting the reading operation or the writing operation which said reading and writing means is executing when said judging means judges that these areas are not continuous.

8. The flash memory system according to claim 7,
wherein said reading and writing means is starting a operation reading data saved in said flash memory or a operation writing data to said flash memory for an area up to a last page in a block specified based on said indication information.

9. The flash memory system according to claim 7,
wherein said reading and writing means is starting a operation reading data saved in said flash memory or a operation writing data to said flash memory for data of a sector count which is more than data of a sector count specified based on said indication information.

10. The flash memory system according to claim 7,
wherein said judging means is judging whether said writing area or said reading area is continuous or not by a logical block address (LBA) and a sector count in said indication information given by said host system.

11. The flash memory system according to claim 7,
wherein said judging means is further judging that said writing area or said reading area is not continuous when a external command included in a new indication information and a external command retained by said indication information retaining means are not same.

12. The flash memory system according to claim 7,
wherein said controlling means is halting the reading operation or the writing operation after finishing reading or writing for the reading area or the writing area specified based on information retained by said indication information retaining means.

13. A method for controlling an access to a flash memory that saved data is erased in a block unit, according to an indication information given by a host system, comprising the steps of:
reading and writing step of starting a operation reading data saved in said flash memory or a operation writing data to said flash memory for an area which is more than a writing area or a reading area specified based on said indication information;
indication information retaining step of retaining said indication information;
judging step of judging whether a writing area or a reading area specified based on a new indication information given by said host system is continuous with the writing area or the reading area specified based on information retained by said indication information retaining step; and
controlling step of maintaining the reading operation or the writing operation which said reading and writing step is executing when said judging step judges that these areas are continuous, and halting the reading operation or the writing operation which said reading and writing step is executing when said judging step judges that these areas are not continuous.

14. The method according to claim 13,
wherein said reading and writing step is starting a operation reading data saved in said flash memory or a operation writing data to said flash memory for an area up to a last page in a block specified based on said indication information.

15. The method according to claim 13,
wherein said reading and writing step is starting a operation reading data saved in said flash memory or a operation writing data to said flash memory for data of a sector count which is more than data of a sector count specified based on said indication information.

16. The method according to claim 13,
wherein said judging step is judging whether said writing area or said reading area is continuous or not by a logical block address (LBA) and a sector count in said indication information given by said host system.

17. The method according to claim 13,
wherein said judging step is further judging that said writing area or said reading area is not continuous when a external command included in a new indication information and a external command retained by said indication information retaining step are not same.

18. The method according to claim 13,
wherein said controlling step is halting the reading operation or the writing operation after finishing reading or writing for the reading area or the writing area specified based on information retained by said indication information retaining step.
